(19) United States
(12) Patent Application Publication
(10) Pub. No.: US 2024/0320487 A1
(43) Pub. Date: Sep. 26, 2024

(54) REPRODUCTIVE TRAINING ARCHITECTURE FOR MACHINE LEARNING

(71) Applicant: TIERNAN X.K. LINDAUER, CEDAR PARK, TX (US)

(72) Inventor: TIERNAN X.K. LINDAUER, CEDAR PARK, TX (US)

(21) Appl. No.: 18/454,672

(22) Filed: Aug. 23, 2023

Related U.S. Application Data
(60) Provisional application No. 63/491,663, filed on Mar. 22, 2023.

(51) Int. Cl. G06N 3/08

(52) U.S. Cl. CPC G06N 3/08

(57) ABSTRACT

A model comprising a neural network is trained using a reproductive training architecture. A reward value and a change in reward (CIR) value are determined for each episode of training the model. If the reward value is less than a target value and if the CIR value is greater than a reproduction threshold value, a child model and corresponding branch is generated. If not, a pruning counter associated with the branch is incremented. The respective models of the branches undergo respective episodes of training. Branches that have a pruning counter greater than a pruning threshold are removed from further training. The pruning threshold may be dynamically determined. During successive episodes, poor branches are pruned, and satisfactory branches are retained. Pruning results in a substantial decrease in the number of unproductive episodes of training, reducing expenditure of computational resources while still resulting in one or more trained models with suitable performance.

### PRIORITY

This application claims priority to, and the benefit of, U.S. Patent Application Ser. No. 63/491,663 filed on Mar. 22, 2023, titled “REPRODUCTIVE TRAINING ARCHITECTURE FOR REINFORCEMENT LEARNING NEURAL NETWORKS”, the contents of which are hereby incorporated by reference into the present disclosure.

### INCORPORATION BY REFERENCE

This disclosure incorporates by reference the material submitted in the Computer Program Listing Appendix filed herewith. The material within the Computer Program Listing Appendix is Copyright 2022 Tiernan X. K. Lindauer, all rights reserved.

### BACKGROUND

Machine learning (ML) systems may utilize a model comprising a neural network (NN) trained to perform a wide variety of operations.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features. The figures are not necessarily drawn to scale, and in some figures, the proportions or other aspects may be exaggerated to facilitate comprehension of particular aspects.

FIG. 1 is a flow diagram of a process of reproductive training, according to some implementations.

FIG. 2 illustrates a graph of operation of a machine learning system using reproductive training, according to some implementations.

FIG. 3 illustrates a graph of results of an experiment comparing reproductive training to conventional training, according to one implementation.

FIG. 4 is a block diagram of a computing device to implement the system, according to some implementations.

While implementations are described herein by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Machine learning (ML) systems may utilize a model comprising a neural network (NN) trained to perform a wide variety of operations. For example, models may be trained to operate equipment, recognize objects in images, generate text or images, and so forth. The model may comprise various layers of processing elements, such as neurons, that perform various functions. Weights or other values may be used to modify how data is transferred between processing elements. During training, input is provided to a model that generates output. The output is assessed, and based on that assessment, feedback may be provided that modifies one or more of the weights in the model. There are many mechanisms that may be used to provide this feedback and modify the models. Each iteration of training a model may be referred to as an episode. After many episodes, the model may produce useful output. For example, after thousands or millions of episodes, the model may be trained to drive a car, generate a picture, or translate text from one language to another.

Performing each episode of training consumes resources, such as using computational hardware, consuming electricity to operate that hardware, and taking some time. Given the great interest in ML and the wide applicability, there are many models being trained, each running through many episodes. For example, some models may utilize thousands of computing devices, consume megawatts of electricity, and take weeks or months to be trained.

Described in this disclosure are systems and techniques implementing a reproductive training architecture to substantially reduce the resources used to train an NN model. For example, experimental results demonstrated a better than 20% decrease in the number of episodes required to train an actor-critic model using reinforcement learning.

The reproductive training architecture (RTA) assesses the results from each episode to determine if an existing model and other models in the same branch should be pruned or if a child model should be generated. The actions of pruning and generating additional branches of models operate to quickly and efficiently determine models that are deemed worthy of expending resources to train.

A reward value and a change in reward (CIR) value are determined for each episode of training a model. The reward value is indicative of performance of the model that was trained in the current episode. The CIR value is indicative of a variance between the output from the model after the current episode and previous output from training of that model during a prior episode. If the reward value is less than a target value and if the CIR value is greater than a reproduction threshold value, a child model and corresponding branch is generated.

If the CIR value is less than or equal to the reproduction threshold value, a pruning counter associated with the branch is incremented. As branches accumulate, they undergo respective episodes of training. Branches that have a pruning counter greater than a pruning threshold are removed from further training. The pruning threshold may be dynamically determined. During successive episodes, poorly performing models and their respective branches are pruned, and satisfactory branches are retained. Pruned branches and their associated models may be deleted or flagged to skip any further training. Pruning results in a substantial decrease in the number of unproductive episodes of training, reducing expenditure of computational resources while still resulting in one or more trained models with suitable performance.

In some implementations, the techniques described herein may be applied to sub-models or portions of a larger model. For example, a multi-head architecture may use these techniques to train a portion of the model associated with one or more heads.

By using the techniques described in this disclosure, machine learning performance may be substantially improved. A trained model may be determined using fewer resources. This provides substantial benefits to designers, operators, and end users as larger and better trained ML systems become feasible.

### Illustrative System

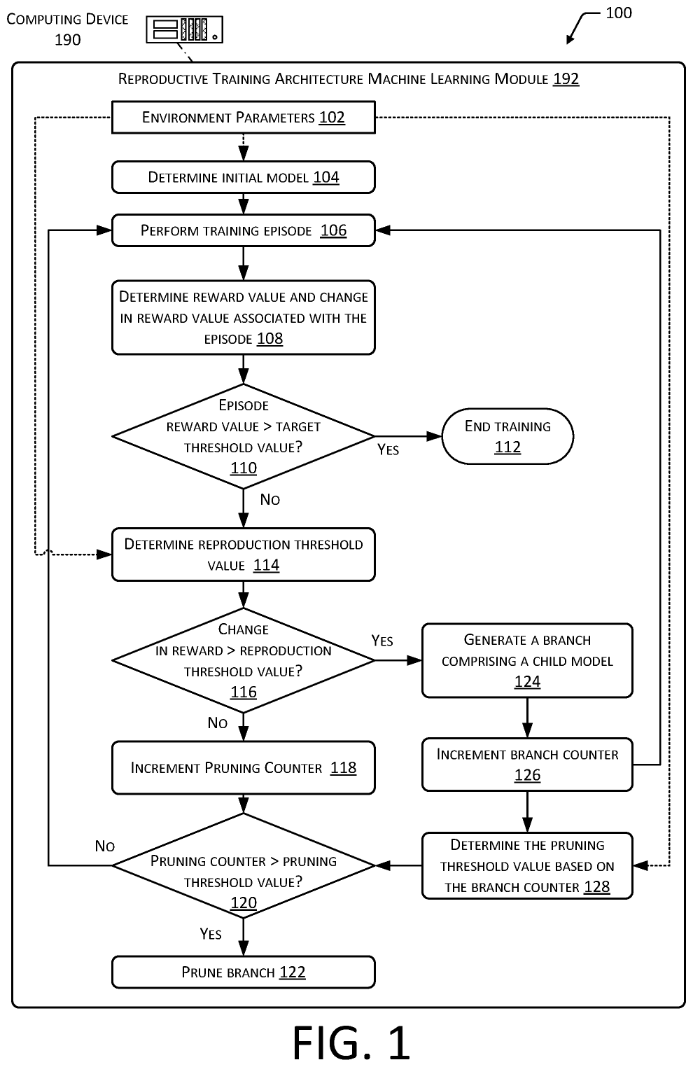

FIG. 1 is a flow diagram 100 of a process of reproductive training as implemented in a reproductive training architecture machine learning (ML) module 192 that is executed on a computing device 190, according to some implementations.

One or more environment parameters 102 are determined. These parameters may be specified by a human operator, automated process, another ML module, and so forth. The environment parameters 102 specify the range of actions of an agent, such as a model during training or inference, a range of observations that may be accepted by the agent, and so forth.

An environment could be OpenAI's “CartPole”, a video game, simulation of the real world, or other situation in which an agent has a task to accomplish. The environment is updated based on the actions taken by each agent, and the agent can sense all or some of these changes based on its scope of observations. The success of this task performed by an agent is measured with a metric designated “reward”. The reward is determined based on completion of one or more objectives in the environment. During training, the agent attempts to maximize the reward over the course of an episode. For example, within the CartPole environment, a reward might be the duration of time that a pole is balanced, how far an agent moved the cart, and so forth. The environment parameters 102 may comprise a fixed target reward that indicates when the agent, or the model that embodies the agent, is deemed to be able to perform the task(s) sufficiently well.

At 104 an initial model is determined. For example, the initial model may comprise a specific arrangement of layers or other data processing elements that form a neural network. One or more weights, bias values, or other values may be associated with the model. Weights in a neural network represent the strengths of connections between neurons and determine the influence of input signals on the network's output. For example, a first set of weights may specify the values of weights, with each weight specifying how much importance one element in the neural network, such as a neuron, assigns to an input or an output. In some implementations, a set of weights associated with a model may be determined, at least in part, using one or more of a pseudorandom number generator, a random number generator, a predefined set of seed values, manual input, and so forth.

In some implementations, the environment parameters 102 may be used to construct the initial model. For example, the environment parameters 102 may specify the input and output dimensions that are based on the action space and the observation space.

At 106 a training episode is performed. For example, an instance of training the initial model using a first input to determine a first output is performed. In some implementations, reinforcement learning techniques may be used during training. For example, the model may utilize an actor-critic, deep Q network (DQN), or other architecture.

In one implementation, actor-critic reinforcement utilizes two components that work together: the “Actor” learns a policy for selecting actions to maximize rewards, and the “Critic” learns to estimate the expected value or advantage of being in a certain state. The actor adjusts its policy based on the critic's evaluations, which guides it toward better actions. This approach combines both policy-based and value-based methods, allowing the actor-critic system to learn more efficiently and handle continuous action spaces. In another implementation, DQN reinforcement learning may utilize deep neural networks to approximate the optimal action-value function. DON learns how to select actions that lead to higher cumulative rewards by iteratively updating through experiences collected while interacting with an environment. In other implementations other types of machine learning algorithms may be utilized.

At 108, as a result of training, one or more metrics are determined. In this illustration, a reward value is determined. The reward value is indicative of performance of the model that was trained in the current episode. A change in reward (CIR) value may also be determined. The CIR value is indicative of a variance between the output from the model after the current episode and previous output from training of that model during a prior episode. For example, during a first episode, the CIR value may be determined based on the first reward value and a fixed value, such as zero.

In other implementations other metrics may be calculated. For example, in some implementations a loss function may be used to calculate a loss value. The loss value may be used instead of, or in addition to, the reward value.

At 110 a determination is made as to whether the reward value associated with the episode is greater than a target threshold value, τ₁. In some implementations, the target threshold value may be a constant, such as input by a user. If yes, the process proceeds to 112. If no, the process proceeds to 114.

At 112 the target threshold value has been exceeded by the output of the training episode, and training ends. In some implementations other actions may be taken. For example, an additional counter or loop may be performed to conduct a specified number of additional training sessions to confirm performance using other inputs.

At 114 a reproduction threshold value, T(R), is determined. The reproduction threshold value may be re-computed during each episode. The reproduction threshold value may be determined using one or more of the following equations.

$$T ( R ) = \frac{- {τ}_{1} {τ}_{0}}{R - {τ}_{1}} \qquad ( EQUATION 1 )$$

$$T ( R ) = \frac{{R}^{2}}{A} + B \qquad ( EQUATION 2 )$$

where:
   T(R) The threshold for the minimum change in reward needed to create a child model. This is compared to the real measured change in reward, and if the real measured change in reward is greater, then the child is created.
   τ₀ The starting reward of the model, i.e. reward gained through a randomly initialized network (although it could be different if you initialize networks in some other way other than random)
   τ₁ The target reward for the model (training stops when a model hits this threshold)
   R The reward after the latest training episode of a model
   A Constant value, may be user defined.
   B Constant value, may be user defined.

With regard to the equations, the use of an asymptotic function provides some benefits during operation as the threshold for creating a new branch becomes significantly stricter as the reward for the model being trained approaches the target reward.

As training progresses, there is less advantage in creating more branches due to the increasing change in running reward. This effect occurs because of the increasing gradient of reward to that optimal solution in weight hyperspace, an n-dimensional space relating weights to their equivalent reward. The dimensionality of weight hyperspace is based on the number of weights used in the model. The increase in reward creates more and more branches, causing dead weight in the network. For example, branches that are created in a region of an increasing gradient of reward to the optimal solution are unnecessary, as the parent branch is already approaching that optimal solution. This problem is addressed by implementing reproduction threshold functions like the ones mentioned herein. As a result, there is a significant reduction in the number of training episodes to reach the target reward.

Once a new child model and corresponding branch is created, it is trained through the same process as the previous model and may utilize a newly randomized seed for the environment. This seed is for the random number generators used in the environment, such as starting the pole at a random angle or providing a randomized drag force. The child model performs a training episode and determines the reward value from that episode. The child model then evaluates if the training should end due to the target reward being reached. From there, it can create a child itself depending on if the change in reward is greater than the output of the reproduction threshold function. After this decision, the model continues the training process. When a new child is created, the parent's pruning counter is reset.

As described with regard to 118, if a child is not created, meaning that the change in reward was not larger than the output of the reproduction threshold function, then the pruning counter is incremented. A separate pruning counter may be maintained for each branch. In some implementations, the pruning counter keeps track of the number of episodes since reproduction, or creation of the last branch. Each time a child model and corresponding branch is created, that pruning counter associated with the parent branch is reset. The creation of a child model may also be recorded for use with the Adaptive Pruning Time Adjustment (APTA) system, which keeps track of the number of branches using a branch counter, and based on the branch counter, adjusts the pruning threshold value. As described with regard to 128, control algorithms like proportional-integral-derivative (PID), model-predictive-control, or linear-quadratic-regulator may be used to adjust this pruning time parameter to the setpoint for the growth of the models.

In another implementation the reproduction threshold value may be a constant. For example, a user may specify a fixed value.

At 116 a determination is made as to whether the change in reward (CIR) is greater than the reproduction threshold value. If yes, the process proceeds to 124, creating a new branch. If no, the process proceeds to 118.

At 118 a pruning counter is incremented. Each branch is associated with a pruning counter. The process then proceeds to 120.

At 120 a determination is made as to whether the pruning counter is greater than a pruning threshold value. In one implementation the pruning threshold value may be global, or applied to all branches. In another implementation, each branch may have a pruning threshold value. The pruning threshold value may be a specified value, or may be determined using one or more functions. If the pruning counter is greater than the pruning threshold value, the process proceeds to 122. If not, the process proceeds to 106.

At 122 the current branch is pruned. Pruned branches may be deleted or flagged, and once flagged will be no longer be trained. The process described herein may continue to operate for remaining branches that have not been pruned. In some implementations, the first branch of the initial model, or root, may be omitted from this determination. For example, the first branch may never be pruned during operation.

Once a branch has been pruned, a branch counter is decremented to indicate this reduction. After pruning, the pruning threshold value may be updated. For example, one or more of the equations or operations described with regard to 128 may be used to update the pruning threshold.

Returning to 116, if the CIR is greater than the reproduction threshold value, the process proceeds to 124. At 124 a child model is generated, creating a new branch. The child model is generated based on at least a portion of the state associated with the preceding model.

In one implementation, the child model may comprise the last trained model, including weight values associated with that last training episode. In another implementation the child model may comprise at least a portion of the last trained model. For example, weight values associated with one or more layers of the previous model may be copied.

Each branch may have an associated optimizer algorithm. Different branches may have different optimizers. Optimizer algorithms may include, but are not limited to, Adam (Kingma, 2014), Adadelta (Zeiler, 2012), and so forth. Other data associated with a branch may include the pruning counter, and a flag or boolean variable indicative of whether the branch has been pruned or not.

In some implementations, additional techniques may be used to determine the child model. For example, an optimizer associated with a given branch may be configured to use a gradient optimization approach when updating the weights during subsequent training episodes of that branch.

At 126 a branch counter is incremented. The branch counter is indicative of the number of branches being trained. The process may then proceed to 106, where subsequent training is performed based on the child model created at 124. The process may also proceed from 126 to 128.

At 128 a pruning threshold value is determined based on the branch counter. The pruning threshold value may be determined after creation of a branch or after the pruning of a branch. For example, after a change in a value of the branch counter, the pruning threshold value may be recalculated. The pruning threshold value may be determined using one or more control algorithms to determine a setpoint value. For example, the pruning threshold value may be determined using a linear quadratic regulator (LQR) algorithm, bang-bang controller, a proportional-integral-derivative controller (PID), and so forth. Equation 3 depicts a PID implementation:

$$u ( t ) = {K}_{p} e ( t ) + {K}_{i} {\sum }_{i = 1}^{t} e ( i ) + {K}_{d} ( e ( t ) - e ( t - 1 ) ) \qquad ( EQUATION 3 )$$

where,
   u(t) PID control variable, the change to the pruning time parameter
   Kₚ Proportional gain
   e(t) Measured error at episode t between the desired and actual number or growth rate of the number of branches
   Kᵢ Integral gain
   K_{d} Derivative gain
   t A discrete variable representing episode number (tϵ [symbol] ₀)—natural numbers including zero

In some implementations the pruning threshold value may be manually set. In this implementation, no information regarding the creation of new child models or any environment parameters is required. The pruning counter for each branch is then compared to this manually set value after incrementing the pruning counter.

In other implementations other values may be used to determine the pruning threshold value. For example, the pruning threshold value may be determined based on the branch counter's value, a growth rate of the branch counter, a velocity of a series of branch counter values, an acceleration of the series of branch counter values, and so forth.

Once the pruning threshold value has been determined, the process may proceed to 120.

In one implementation, at least a portion of the RTA may be implemented using the following algorithm;

```
ALGORITHM 1
X = [ ] List of all child branches
K = False Boolean for being pruned or not
R_{running} = 0 Current branch running reward
C_{reproduce} = 0 Reproduction counter
τ₁ ← t Get threshold for the running reward, passed from the user
Kₜₕᵣₑₛₕ ← k Get pruning hyperparameter, passed from the user (or specified by APTA)
T(P) ← t Get reproduction threshold function, passed from the user or automatically
generated
W~N(0, σ²) Initialize weights, in this example randomly
while R_{running} < τ₁do
      if C_{reproduce} > Kₜₕᵣₑₛₕ then
        K = True
    end if
      if not K then Check pruning condition
        R_{running}, W ←self.runEpisode( )
        C_{reproduce}++
    end if
      if ΔR_{running} ≥ T(R_{running}) then
        X.addChild(R_{running}, W_{new})
Reset branch 1
episode Update this branch
        C_{reproduce} = 0
    end if
                                            If ΔR_{running} ≥ threshold function, create child
      child.update( ) for child in X
      end while save W Resets W and R_{running}
```

The process described above may be iterated. In some implementations, the process may be implemented using recursive loops. In some implementations, one or more of the operations described may be performed in a different order. For example, the operations associated with 114 may be determined before 110.

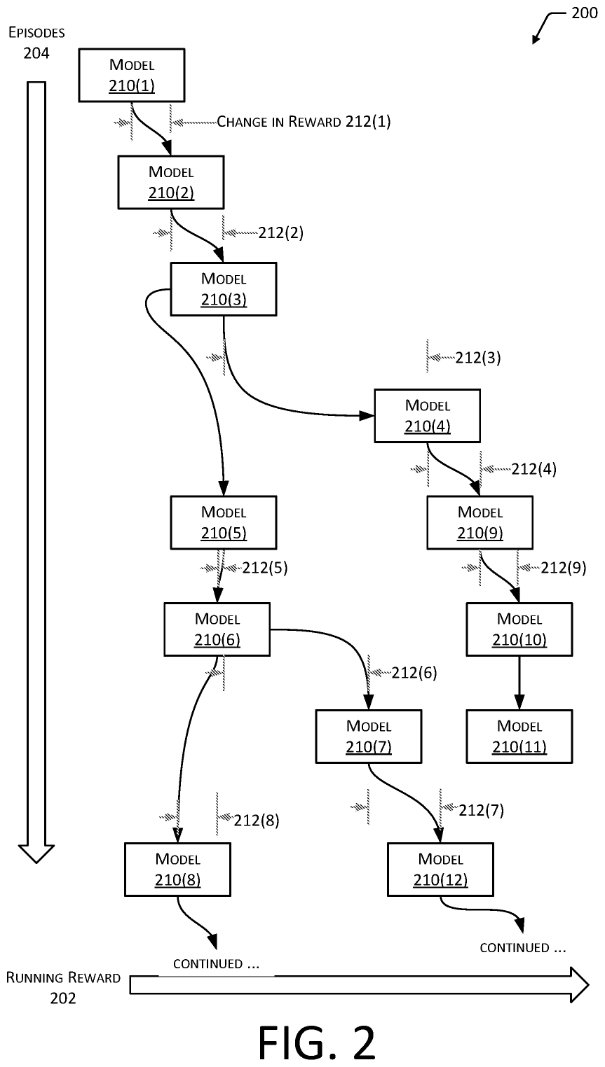

FIG. 2 illustrates a graph 200 of operation of the reproductive training, according to some implementations. The graph 200 depicts a horizontal axis indicating running reward 202 comprising the reward value of the output of a latest (in time) corresponding training episode, with the running reward 202 increasing left to right. A vertical axis indicates episodes 204, with earliest episodes at the top and latest episodes at the bottom. In some implementations, episodes associated with different branches may be performed in parallel. Parallel operations may be performed synchronously or asynchronously.

Depicted are a plurality of models 210. Each model 210 comprises a particular neural network and associated values, such as model weights, bias values, and so forth.

For ease of illustration and not as a limitation, in this illustration the first digit in parentheses indicates the model.

Also depicted is a change in reward 212 that is indicative of the variance between output of a current training episode and output of a prior training episode for that same model.

A model 210(1) was trained during a first episode. The first reward value (not shown) is determined based on the output resulting from the first episode. Because the first reward value is less than the target threshold value, another training episode is performed.

A first reproduction threshold value (not shown) is determined, as described above. For example, the first reproduction threshold value may be determined based on the target threshold value and the first reward value, as well as the current reward. At this time, no change in reward (CIR) value is available as there is no previous output to compare against. As a result, the process proceeds.

A first branch comprises the model 210(1) and its direct descendants that exhibit a change in reward that is less than the reproduction thresholds for each episode. For example, the first branch comprises the models 210(1), (2), (3), (5), (6), and (8) in this illustration.

The second model 210(2) comprises the model 210(1) as trained during the first episode and subsequently trained again during a second episode. A second reward value is determined based on the output resulting from the second episode. Because the second reward value is less than the target threshold value, the process proceeds.

A second reproduction threshold value is determined. For example, the second reproduction threshold value may be determined based on the target threshold value and the second reward value.

A CIR 212(1) is determined based on the second reward value and the first reward value. In this implementation, the CIR 212(1) is less than the second reproduction threshold value. As a result, the process proceeds without generating another a child model and corresponding branch.

A first pruning counter (not shown) associated with a first branch that includes the first model 210(1) is incremented. Because that first pruning counter is less than a pruning threshold value, the process proceeds to perform another training episode.

The model 210(3) comprises the model 210(2) as trained during the second episode, as trained again during a third episode. A third reward value is determined based on the output resulting from the third episode. Because the third reward value is less than the target threshold value, the process proceeds.

A third reproduction threshold value is determined. For example, the third reproduction threshold value may be determined based on the target threshold value and third reward value.

A CIR 212(2) is determined based on the third reward value and the second reward value. In this implementation, the CIR 212(2) is less than the third reproduction threshold value. The first pruning counter is incremented. Because that first pruning counter remains less than the pruning threshold value, the process proceeds to perform another training episode.

The model 210(4) comprises the model 210(3) as trained during the third episode as trained again during a fourth episode (for the first model). A fourth reward value is determined based on the output resulting from the fourth episode. Because the fourth reward value is less than the target threshold value, the process proceeds.

A fourth reproduction threshold value is determined. For example, the fourth reproduction threshold value may be determined based on the target threshold value and fourth reward value.

A CIR 212(3) is determined based on the fourth reward value and the third reward value. In this implementation, the CIR 212(3) is greater than the third reproduction threshold value. As a result, a second branch is formed that begins with the model 210(4). A root of the second branch may comprise a copy of the model 210(3) that is associated with a change in reward that exceeded the associated reproduction threshold value, triggering the creation of the branch. A second pruning counter, associated with the second branch, is set to an initial value. For example, the second pruning counter associated with the second branch may be set to 0 and incremented during subsequent episodes associated with that branch. Returning to the example illustrated, because that second pruning counter remains less than the pruning threshold value, the process proceeds to perform another training. Operation of the second branch is discussed in more detail below.

The second branch comprises the model 210(4) and its direct descendants that exhibit a change in reward that is less than the reproduction thresholds for each episode. For example, the second branch comprises the models 210(4), (9), (10), and (11) in this illustration.

Returning to the first branch, model 210(5) is generated based on at least a portion of the state associated with the preceding model 210(3). Following the creation of a new branch, the existing branch may be reset to its previous state and training may continue on that branch. For example, one or more of the weights associated with the model 210(3) may be copied to generate the model 210(5). In some implementations, one or more parameters of the model 210(5) may be modified. For example, one or more parameters associated with operation of an optimizer that adjusts the weights during each training episode may be reset to a default state.

A fifth reward value is determined based on the output resulting from the fifth episode. Because the fifth reward value is less than the target threshold value, the process proceeds.

A fifth reproduction threshold value is determined. For example, the fifth reproduction threshold value may be determined based on the target threshold value and the fifth reward value.

A CIR 212(5) is determined based on the fifth reward value and the fourth reward value. In this implementation, the CIR 212(5) is less than the fifth reproduction threshold value. As a result, the process proceeds without generating a child model and corresponding branch.

A first pruning counter (not shown) associated with a first branch that includes the model 210(1) is incremented. Because that first pruning counter is less than a pruning threshold value, the process proceeds to perform another training episode.

The model 210(6) comprises the model 210(5) as trained during the fifth episode and subsequently trained again during a sixth episode. A sixth reward value is determined based on the output resulting from the sixth episode. Because the sixth reward value is less than the target threshold value, the process proceeds.

A sixth reproduction threshold value is determined. For example, the sixth reproduction threshold value may be determined based on the target threshold value and the sixth reward value.

A CIR 212(5) is determined based on the sixth reward value and the first reward value. Not that in this example, the CIR 212(5) is negative, in that the model 210(6) was deemed to have performed worse than the preceding model 210(5). In this implementation, the CIR 212(5) is less than the sixth reproduction threshold value. As a result, the process proceeds without generating another model.

A first pruning counter (not shown) associated with a first branch that includes the model 210(6) is incremented. Because that first pruning counter is less than a pruning threshold value, the process proceeds to perform another training episode.

The model 210(7) comprises the model 210(6) as trained during the sixth episode, as trained again during a seventh episode. A seventh reward value is determined based on the output resulting from the seventh episode. Because the seventh reward value is less than the target threshold value, the process proceeds.

A seventh reproduction threshold value is determined. For example, the seventh reproduction threshold value may be determined based on the target threshold value and seventh reward value.

A CIR 212(6) is determined based on the sixth reward value and the seventh reward value. In this implementation, the CIR 212(6) is greater than the sixth reproduction threshold value. As a result, a third branch is formed that begins with the model 210(7). A root of a branch may comprise a copy of the model 210 that is associated with a change in reward that exceeded the associated reproduction threshold value, triggering the creation of the branch. Operation of the third branch is discussed in more detail below.

The third branch comprises the model 210(7) and its direct descendants that exhibit a change in reward that is less than the reproduction thresholds for each episode. For example, the third branch comprises the models 210(7) and (12) in this illustration.

The model 210(8) comprises the model 210(6) as trained during the sixth episode. An eighth reward value is determined based on the output resulting from the eighth episode. In this illustration, the eighth reward value is a negative. Because the eighth reward value is less than the target threshold value, the process proceeds. As described above with regard to model 210(5), following the creation of a new branch, the existing branch may be reset to its previous state and training may continue on that branch.

An eighth reproduction threshold value is determined. For example, the eighth reproduction threshold value may be determined based on the target threshold value and eighth reward value.

A CIR 212(8) is determined based on the eighth reward value and the seventh reward value. In this implementation, the CIR 212(8) is less than the eighth reproduction threshold value. The first pruning counter associated with the first branch is incremented. Because that first pruning counter remains less than the pruning threshold value, the process proceeds to perform another training episode. The process may then continue.

Returning to the second branch, the model 210(9) comprises the model 210(4) as trained during the fourth episode, as trained again during a ninth episode. A ninth reward value is determined based on the output resulting from the ninth episode. Because the ninth reward value is less than the target threshold value, the process proceeds.

A ninth reproduction threshold value is determined. For example, the ninth reproduction threshold value may be determined based on the target threshold value and ninth reward value.

A CIR 212(4) is determined based on the ninth reward value and the fourth reward value. In this implementation, the CIR 212(4) is less than the ninth reproduction threshold value. The second pruning counter is incremented. Because that second pruning counter remains less than the pruning threshold value, the process proceeds to perform another training episode.

The model 210(10) comprises the model 210(9) as trained during the ninth episode, as trained again during a tenth episode. A tenth reward value is determined based on the output resulting from the tenth episode. Because the tenth reward value is less than the target threshold value, the process proceeds.

A tenth reproduction threshold value is determined. For example, the tenth reproduction threshold value may be determined based on the target threshold value and tenth reward value.

A CIR 212(9) is determined based on the tenth reward value and the ninth reward value. In this implementation, the CIR 212(9) is less than the tenth reproduction threshold value. The second pruning counter is incremented. Because that second pruning counter remains less than the pruning threshold value, the process proceeds to perform another training episode.

The model 210(11) comprises the model 210(10) as trained during the tenth episode, as trained again during an eleventh episode. An eleventh reward value is determined based on the output resulting from the eleventh episode. Because the eleventh reward value is less than the target threshold value, the process proceeds.

An eleventh reproduction threshold value is determined. For example, the eleventh reproduction threshold value may be determined based on the target threshold value and eleventh reward value.

A CIR 212(10) (not shown) is determined based on the eleventh reward value and the tenth reward value. In this implementation, the CIR 212(10) is less than the eleventh reproduction threshold value. The second pruning counter is incremented. Because the second pruning counter is greater than the pruning threshold value, the second branch is pruned.

Returning to the third branch, the model 210(7) comprises the model 210(6) as trained during the sixth episode and trained again during a seventh episode. A seventh reward value is determined based on the output resulting from the seventh episode. Because the seventh reward value is less than the target threshold value, the process proceeds.

A seventh reproduction threshold value is determined. For example, the seventh reproduction threshold value may be determined based on the target threshold value and seventh reward value.

A CIR 212(6) is determined based on the seventh reward value and the sixth reward value. In this implementation, the CIR 212(6) is greater than the seventh reproduction threshold value. As a result, the third branch is formed that begins with the model 210(7). A root of the third branch may comprise a copy of the model 210(6) that is associated with a change in reward 212 that exceeded the associated reproduction threshold value, triggering the creation of the branch.

A third pruning counter associated with the third branch is incremented. Because that third pruning counter remains less than the pruning threshold value, the process proceeds to perform another training.

The model 210(12) comprises the model 210(7) as trained during the seventh episode, as trained again during a twelfth episode. A twelfth reward value is determined based on the output resulting from the twelfth episode. Because the twelfth reward value is less than the target threshold value, the process proceeds.

A twelfth reproduction threshold value is determined. For example, the twelfth reproduction threshold value may be determined based on the target threshold value and twelfth reward value.

A CIR 212(7) is determined based on the twelfth reward value and the seventh reward value. In this implementation, the CIR 212(7) is less than the twelfth reproduction threshold value. The third pruning counter is incremented. Because that third pruning counter remains less than the pruning threshold value, the process proceeds to perform another training episode. The process may then proceed.

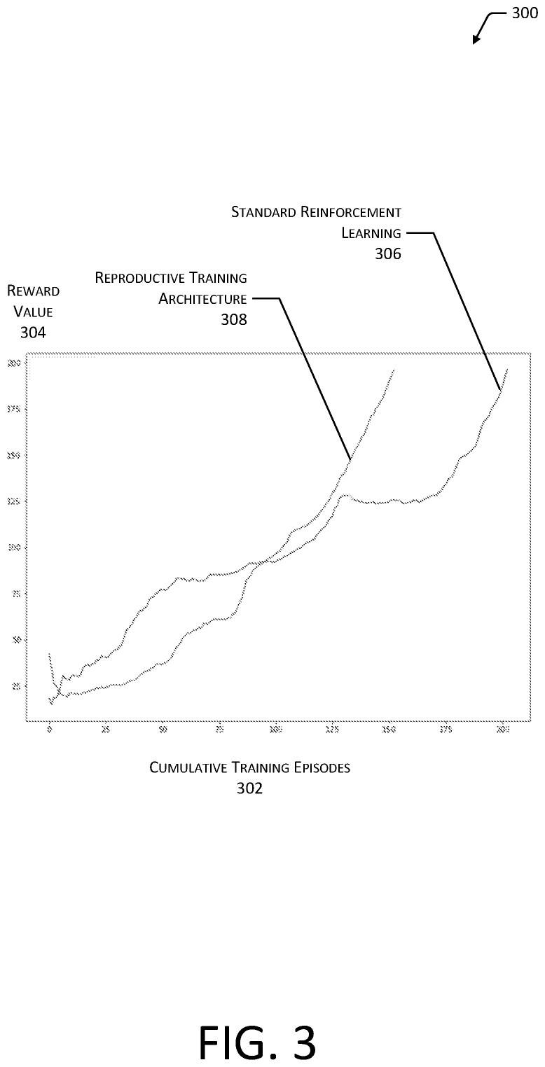

FIG. 3 illustrates a graph 300 of results of an experiment comparing reproductive training to conventional training of an actor-critic model in the OpenAI CartPole environment, according to one implementation.

The graph 300 depicts a horizontal axis indicating cumulative training episodes 302, and a vertical axis indicating running reward value 304. The running reward value 304 comprises the reward value of the output of the corresponding training episode.

A line indicating performance of standard reinforcement learning 306 is depicted, as well as the reproductive training architecture (RTA) 308.

To determine the results depicted in this graph 300, an actor-critic architecture was used. The standard reinforcement learning 306 and the reproductive training architecture 308 both were implemented using TensorFlow. Both use one model and one Adam optimizer (Kingma & Ba, 2014) with a learning rate of 0.01. The environment used was OpenAI's CartPole environment (Brockman et al., 2016). In this environment, the actor is required to keep a (simulated) pole balanced on top of a (simulated) cart which can move left and right through the actor's actions, while staying in a certain range of the origin. The pole is subject to (simulated) gravity, and if the pole falls below a certain angle, then the actor loses.

The RTA 308 in this example used a pruning hyperparameter of 100, subsequent weight updates, and a constant reproduction threshold function of 75, or T(P)=75.

For this model, if the improvement in running reward 304 is greater than 75 between any two instances, a new branch will be created. The RTA 308 also uses Adam optimizers with a learning rate η of 0.01. Both architectures used a γ (discount factor) of 0.99. The reward threshold τ₁ was 195, such that the model is considered trained after the running reward is greater than or equal to 195. After 100 pairs of networks were run, the results were as below:

TABLE 1

| | Mean Number of | Standard Deviation of |
|---|---|---|
| Network | Episodes | Episodes |
| Actor-Critic | 255.49 | 163.67 |
| REPNET | 200.57 | 44.27 |

Compared to the normal actor-critic method, the results show a 21.5% improvement in the mean and a 72.95% improvement in the standard deviation. These results therefore indicate that RTA 308 provides a model that is quicker to train and more consistent when training.

A result from this experiment is depicted in FIG. 3. In this graph, each data point represents a unique episode of training.

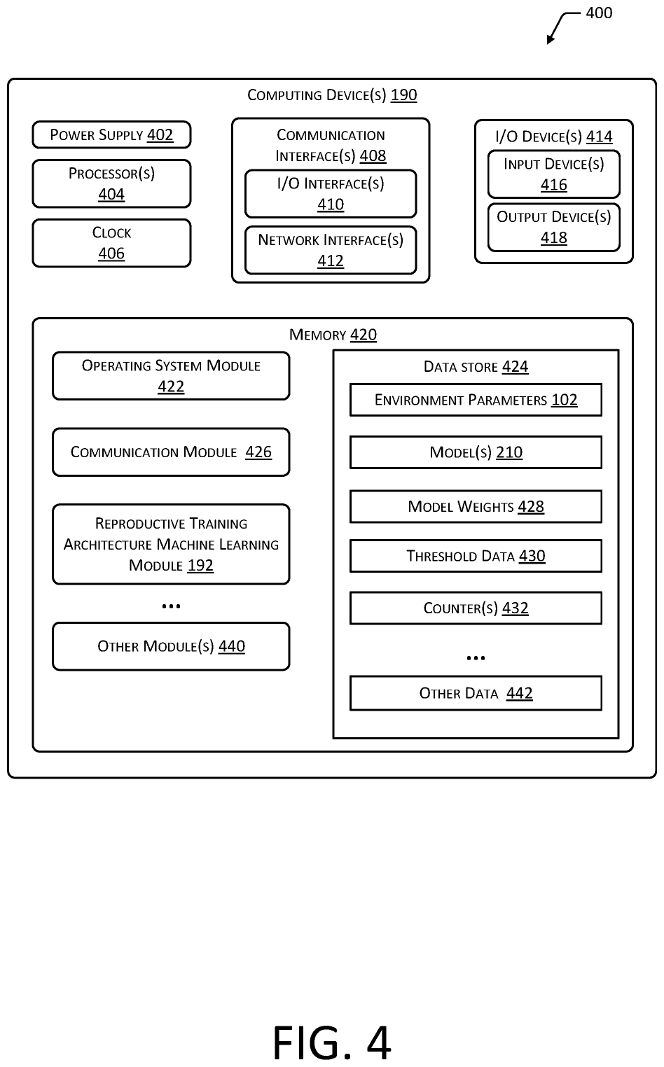

FIG. 4 is a block diagram 400 of the computing device 190 to implement the system 100, according to some implementations. The computing device 190 may be implemented as one or more of an “embedded system”, “on-demand computing”, “software as a service (Saas)”, “platform computing”, “network-accessible platform”, “cloud services”, “data centers”, and so forth. Services provided by the computing device 190 may be distributed across one or more physical or virtual devices.

One or more power supplies 402 may be configured to provide electrical power suitable for operating the components in the computing device 190. The one or more power supplies 402 may comprise batteries, connections to an electric utility, and so forth. The computing device 190 may include one or more hardware processors 404 (processors) configured to execute one or more stored instructions. For example, the hardware processors 404 may include application specific integrated circuits (ASICs), field-programmable gate arrays (FPGAs), digital signal processors (DSPs), hardware accelerators, graphics processing units (GPUs), and so forth. For example, the processors 404 may include hardware optimized to perform one or more functions of the reproductive training architecture machine learning module 192. The processors 404 may comprise one or more cores. One or more clocks 406 may provide information indicative of date, time, ticks, and so forth.

The computing device 190 may include one or more communication interfaces 408 such as input/output (I/O) interfaces 410, network interfaces 412, and so forth. The communication interfaces 408 enable the computing device 190, or components thereof, to communicate with other devices or components. The communication interfaces 408 may include one or more I/O interfaces 410. The I/O interfaces 410 may comprise Inter-Integrated Circuit (I2C), Serial Peripheral Interface bus (SPI), Universal Serial Bus (USB) as promulgated by the USB Implementers Forum, RS-232, Peripheral Component Interconnect (PCI), serial AT attachment (SATA), and so forth.

The I/O interface(s) 410 may couple to one or more I/O devices 414. The I/O devices 414 may include input devices 416 such as one or more of a sensor, keyboard, mouse, scanner, and so forth. The I/O devices 414 may also include output devices 418 such as one or more of a display device, printer, audio speakers, and so forth. In some embodiments, the I/O devices 414 may be physically incorporated with the computing device 190 or may be externally placed.

The network interfaces 412 may be configured to provide communications between the computing device 190 and other devices, such as routers, access points, and so forth. The network interfaces 412 may include devices configured to couple to personal area networks (PANs), local area networks (LANs), wireless local area networks (WLANS), wide area networks (WANs), and so forth. For example, the network interfaces 412 may include devices compatible with Ethernet, Wi-Fi, Bluetooth, and so forth.

The computing device 190 may also include one or more buses or other internal communications hardware or software that allow for the transfer of data between the various modules and components of the computing device 190.

As shown in FIG. 4, the computing device 190 includes one or more memories 420. The memory 420 may comprise one or more non-transitory computer-readable storage media (CRSM). The CRSM may be any one or more of an electronic storage medium, a magnetic storage medium, an optical storage medium, a quantum storage medium, a mechanical computer storage medium, and so forth. The memory 420 provides storage of computer-readable instructions, data structures, program modules, and other data for the operation of the computing device 190. A few example functional modules are shown stored in the memory 420, although the same functionality may alternatively be implemented in hardware, firmware, or as a system on a chip (SoC).

The memory 420 may include at least one operating system (OS) module 422. The OS module 422 is configured to manage hardware resource devices such as the I/O interfaces 410, the I/O devices 414, the communication interfaces 408, and provide various services to applications or modules executing on the processors 404. The OS module 422 may implement a variant of the FreeBSD operating system as promulgated by the FreeBSD Project; other UNIX or UNIX-like variants; a variation of the Linux operating system as promulgated by Linus Torvalds; the Windows operating system from Microsoft Corporation of Redmond, Washington, USA; and so forth.

Also stored in the memory 420 may be a data store 424 and one or more of the following modules. For example, these modules may be executed as foreground applications, background tasks, daemons, and so forth. The data store 424 may use a flat file, database, linked list, tree, executable code, script, or other data structure to store information. In some implementations, the data store 424 or a portion of the data store 424 may be distributed across one or more other devices including other computing devices 190, network attached storage devices, and so forth.

The data store 424 may store one or more of models 210, model weights 428, threshold data 430, counters 432, and so forth. The model weights 428 may comprise the weights, bias values, or other values that embody the training of the models 210. The threshold data 430 may comprise the target threshold value, reproduction threshold value, and so forth. The counters 432 may comprise the branch counter, pruning counters, and so forth.

A communication module 426 may be configured to establish communications with other computing devices 190 or other devices. The communications may be authenticated, encrypted, and so forth.

The reproductive training architecture machine learning module 192 is stored in the memory 420 and when executed performs the functions described herein.

Other modules 440 may also be present in the memory 420 as well as other data 442 in the data store 424. For example, an administrative module may provide an interface to allow operators to modify the environment parameters 102, and so forth.

The processes discussed herein may be implemented in hardware, software, or a combination thereof. In the context of software, the described operations represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
a memory, storing first computer-executable instructions; and
a hardware processor to execute the first computer-executable instructions to:
determine a first model comprising a neural network, wherein the first model is associated with a first branch;
determine, during a first training episode using the first model, a first output;
determine, based on the first output, a first reward value indicative of performance of the first model during the first training episode;
determine a first change in reward (CIR) value indicative of a variance between the first output and one of: a previous output, or a specified value; and
determine a first reproduction threshold value based on one or more of the first reward value or the first CIR value.

2. The system of claim 1, the hardware processor to execute the first computer-executable instructions to:
determine that the first reward value is less than or equal to a target threshold value;
determine that the first CIR value is greater than the first reproduction threshold value;
generate a second model based at least in part on the first model, wherein the second model is associated with a second branch;
increment a branch counter;
determine, during a second training episode using the second model, a second output; and
determine, based on the second output, a second reward value indicative of performance of the second model during the second training episode.

3. The system of claim 2, wherein:
the first model comprises a first set of weights;
the second model comprises a second set of weights; and
the first set of weights differs from the second set of weights.

4. The system of claim 1, the hardware processor to execute the first computer-executable instructions to:
determine that the first reward value is less than or equal to a target threshold value;
determine that the first CIR value is greater than the first reproduction threshold value;
generate a second model based at least in part on the first model, wherein the second model is associated with a second branch;
increment a branch counter;
determine a pruning threshold value based on the branch counter;
determine, during a second training episode using the second model, a second output;
determine, based on the second output, a second reward value indicative of performance of the second model during the second training episode;
determine a second CIR value indicative of a variance between the second output and one of: the first output, or a second specified value;
determine that the first CIR value is less than or equal to the first reproduction threshold value;
increment a first pruning counter;
determine that the first pruning counter is greater than the pruning threshold value; and
prune the second model and one or more other models associated with the second branch.

5. The system of claim 4, the hardware processor to execute the first computer-executable instructions to:
determine the pruning threshold value using a proportional-integral-derivative (PID) algorithm, wherein input to the PID algorithm is based at least in part on the branch counter.

6. The system of claim 1, the hardware processor to execute the first computer-executable instructions to:
determine that the first reward value is less than or equal to a target threshold value;
determine that the first CIR value is less than or equal to the first reproduction threshold value;
increment a first pruning counter;
determine that the first pruning counter is greater than a pruning threshold value; and
prune the first model.

7. The system of claim 6, the hardware processor to execute the first computer-executable instructions:
set a flag associated with the first model to indicate that the first model is ineligible for further training episodes.

8. The system of claim 1, the hardware processor to execute the first computer-executable instructions to:
determine that the first reward value is less than or equal to a target threshold value;
determine that the first CIR value is less than or equal to the first reproduction threshold value;
increment a first pruning counter;
determine that the first pruning counter is less than or equal to a pruning threshold value; and
determine, during a second training episode using the first model, a second output.

9. The system of claim 1, the hardware processor to execute the first computer-executable instructions to:
determine the first reproduction threshold value T(R) using the equation:
$$T ( R ) = \frac{- {τ}_{1} {τ}_{0}}{R - {τ}_{1}}$$
where:
τ₀ is based on the first reward value;
τ₁ is a target threshold value; and
R is a reward value associated with a last training episode.

10. A computer-implemented method comprising:
determining a first model comprising an artificial neural network, wherein the first model is associated with a first branch;
determining, during a first training episode using the first model, a first output;
determining, based on the first output, a first reward value indicative of performance of the first model during the first training episode;
determining a first change in reward (CIR) value indicative of a variance between the first output and one of: a previous output, or a specified value; and
determining a first reproduction threshold value based on one or more of the first reward value or the first CIR value.

11. The method of claim 10, further comprising:
determining that the first reward value is less than or equal to a target threshold value;
determining that the first CIR value is greater than the first reproduction threshold value;
generating a second model based at least in part on the first model, wherein the second model is associated with a second branch;
incrementing a branch counter;
determining, during a second training episode using the second model, a second output; and
determining, based on the second output, a second reward value indicative of performance of the second model during the second training episode.

12. The method of claim 11, wherein:
the first model comprises a first set of weights;
the second model comprises a second set of weights; and
the first set of weights differs from the second set of weights.

13. The method of claim 10, further comprising:
determining that the first reward value is less than or equal to a target threshold value;
determining that the first CIR value is greater than the first reproduction threshold value;
generating a second model based at least in part on the first model, wherein the second model is associated with a second branch;
incrementing a branch counter;
determining a pruning threshold value based on the branch counter;
determining, during a second training episode using the second model, a second output;
determining, based on the second output, a second reward value indicative of performance of the second model during the second training episode;
determining a second CIR value indicative of a variance between the second output and one of: the first output, or a second specified value;
determining that the first CIR value is less than or equal to the first reproduction threshold value;
incrementing a first pruning counter;
determining that the first pruning counter is greater than the pruning threshold value; and
pruning the second model.

14. The method of claim 13, further comprising:
determining the pruning threshold value using a proportionate integral derivative (PID) algorithm, wherein input to the PID algorithm is based on one or more of:
the branch counter, or
an environment parameter.

15. The method of claim 10, further comprising:
determining that the first reward value is less than or equal to a target threshold value;
determining that the first CIR value is less than or equal to the first reproduction threshold value;
incrementing a first pruning counter;
determining that the first pruning counter is greater than a pruning threshold value; and
pruning the first model.

16. The method of claim 15, further comprising:
setting a flag associated with the first model to indicate that the first model is ineligible for further training episodes.

17. The method of claim 10, further comprising:
determining that the first reward value is less than or equal to a target threshold value;
determining that the first CIR value is less than or equal to the first reproduction threshold value;
incrementing a first pruning counter;
determining that the first pruning counter is less than or equal to a pruning threshold value; and
determining, during a second training episode using the first model, a second output.

18. The method of claim 10, further comprising:
determining the first reproduction threshold value T(R) using the equation:
$$T ( R ) = \frac{- {τ}_{1} {τ}_{0}}{R - {τ}_{1}}$$
where:
τ₀ is based on the first reward value;
τ₁ is a target threshold value; and
R is a reward value associated with a last training episode.

19. A computer-implemented method comprising:
determining a first model comprising an artificial neural network, wherein the first model is associated with a first branch;
determining, during a first training episode using the first model, a first output;
determining, based on the first output, a first reward value indicative of performance of the first model during the first training episode;
determining a first change in reward (CIR) value indicative of a variance between the first output and one of: a previous output, or a specified value;
determining that the first reward value is less than or equal to a target threshold value;
determining a first reproduction threshold value based on one or more of the first reward value or the first CIR value;
determining that the first CIR value is greater than the first reproduction threshold value;
generating a second model based at least in part on the first model, wherein the second model is associated with a second branch;
incrementing a branch counter; and
determining a pruning threshold value based on the branch counter.

20. The method of claim 19, further comprising:
determining the pruning threshold value using a proportionate integral derivative (PID) algorithm, wherein input to the PID algorithm is based on one or more of:
the branch counter, or
an environment parameter.
